(19) United States
(12) Patent Application Publication
(10) Pub. No.: US 2024/0243244 A1
(43) Pub. Date: Jul. 18, 2024

(54) SYSTEM FOR CONTROLLING THICKNESS OF ELECTRODE

(71) Applicants: HYUNDAI MOTOR COMPANY, Seoul (KR); KIA CORPORATION, Seoul (KR)

(72) Inventors: Chan Bum Park, Suwon-si (KR); Han Nah Song, Ansan-si (KR)

(21) Appl. No.: 18/223,673

(22) Filed: Jul. 19, 2023

(30) Foreign Application Priority Data
Jan. 12, 2023 (KR) 10-2023-0004583

(51) Int. Cl. H01M 4/04

(52) U.S. Cl. CPC H01M 4/0433; H01M 2004/021

(57) ABSTRACT

A system for controlling a thickness of an electrode includes a first press configured to accommodate an electrode powder consecutively supplied and press the electrode powder into an electrode sheet in the form of a film, a second press disposed downstream of the first press and configured to receive the electrode sheet and press the received electrode sheet, a measuring device disposed downstream of the second press and configured to measure a thickness of the electrode sheet in real time, and a controller configured to change an operating condition of the first press or an operating condition of the second press based on thickness information measured by the measuring device.

### CROSS REFERENCE TO RELATED APPLICATIONS

This application claims under 35 U.S.C. § 119(a) the benefit of priority to Korean Patent Application No. 10-2023-0004583 filed on Jan. 12, 2023, the entire contents of which are incorporated herein by reference.

### BACKGROUND

### (a) Technical Field

The present disclosure relates to an electrode of a battery, and more specifically, to controlling a thickness of an electrode.

### (b) Background Art

Recently, the use of secondary batteries is expanding, such as electronic devices, electric vehicles, and energy storage devices. Lithium ion batteries are one of the most widely used types of the secondary batteries.

Electrodes of the secondary batteries have been mainly manufactured through a wet method. However, research and development on manufacturing dry electrodes has recently been actively conducted as a solvent used in the wet method is not required, an energy density of the battery can be improved, and a production cost of the battery can be reduced.

The dry electrodes are manufactured by applying a binder on a current collector, and then injecting and pressing a powder.

### SUMMARY

The present disclosure is directed to providing a system and method for controlling a thickness of an electrode capable of accurately and stably controlling a thickness of the electrode when a dry electrode is manufactured.

The objects of the present disclosure are not limited to the above-described object, and other objects that are not mentioned will be able to be understood by those skilled in the art to which the present disclosure pertains (hereinafter referred to as “those skilled in the art”) from the following description.

The characteristics of the present disclosure for achieving the object of the present disclosure and performing characteristic functions of the present disclosure to be described below are as follows.

According to some embodiments of the present disclosure, a system for controlling a thickness of an electrode includes a first press configured to accommodate an electrode powder consecutively supplied and press the electrode powder into an electrode sheet in the form of a film, a second press disposed downstream of the first press and configured to receive the electrode sheet and press the received electrode sheet, a measuring device disposed downstream of the second press and configured to measure a thickness of the electrode sheet in real time, and a controller configured to change an operating condition of the first press or an operating condition of the second press based on thickness information measured by the measuring device.

According to some embodiments of the present disclosure, a system for controlling a thickness of an electrode includes a first press configured to accommodate an electrode powder consecutively supplied and press the electrode powder into an electrode sheet in the form of a film, a second press disposed downstream of the first press and configured to receive the electrode sheet and press the received electrode sheet, a measuring device disposed downstream of the second press and configured to measure a weight of the electrode sheet in real time, and a controller configured to calculate a density of the electrode sheet based on weight information measured by the measuring device and change an operation condition of the first press or the second press based on the calculated density.

According to the present disclosure, provided is a system and method for controlling the thickness of the electrode capable of accurately and stably controlling the thickness of the electrode when the dry electrode is manufactured.

The effects of the present disclosure are not limited to the above-described effect, and other effects that are not mentioned will be able to be clearly recognized by those skilled in the art from the following description.

It is understood that the term “automotive” or “vehicular” or other similar term as used herein is inclusive of motor automotives in general such as passenger automobiles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels derived from resources other than petroleum). As referred to herein, a hybrid automotive is an automotive that has two or more sources of power, for example both gasoline-powered and electric-powered automotives.

The above and other features of the disclosure are discussed infra.

### BRIEF DESCRIPTION OF THE FIGURES

The above and other features of the present disclosure will now be described in detail with reference to certain exemplary examples thereof illustrated in the accompanying drawings which are given herein below by way of illustration only, and thus are not limitative of the present disclosure, and wherein:

FIG. 1 shows a configuration diagram of a system for controlling a thickness of an electrode according to the present disclosure;

FIG. 2 is a flowchart of electrode thickness control according to the present disclosure;

FIG. 3 shows a first press of the system for controlling the thickness of the electrode according to the present disclosure,

FIG. 4 shows a second press of the system for controlling the thickness of the electrode according to the present disclosure;

FIG. 5 shows an exemplary thickness distribution of an electrode acquired by a measuring device of the system for controlling the thickness of the electrode according to the present disclosure;

FIGS. 6A and 6B are flowcharts of the electrode thickness control according to some embodiments of the present disclosure;

FIG. 7 is a flowchart of electrode thickness control according to another embodiment of the present disclosure; and

FIG. 8 shows a flowchart of feedback control of the electrode thickness according to the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in section by the particular intended application and use environment.

In the figures, reference numbers refer to the same or equivalent sections of the present disclosure throughout the several figures of the drawing.

### DETAILED DESCRIPTION

Specific structural or functional descriptions presented in the embodiments of the present disclosure are merely illustrative for the purpose of describing embodiments according to the concept of the present disclosure, and the embodiments according to the concept of the present disclosure may be implemented in various forms. In addition, the present disclosure should not be construed as being limited to the embodiments described in this specification and should be understood as including all modifications, equivalents, or substitutes included in the spirit and scope of the present disclosure.

Meanwhile, in the present disclosure, terms such as first and/or second may be used to describe various components, but the components are not limited by the terms. The terms are used only for the purpose of distinguishing one component from other components, for example, without departing from the scope according to the concept of the present disclosure, and a first component may be referred to as a second component, and similarly, the second component may also be referred to as the first component.

It should be understood that when a certain component is described as being “connected” or “coupled” to another component, the certain component may be directly connected or coupled to another component, but other components may also be present therebetween. On the other hand, it should be understood that when a certain is described as being “directly connected” or “in direct contact” with another component, no other components are present therebetween. Other expressions used to describe the relationship between the components, such as “between” and “directly between” or “adjacent to” and “directly adjacent to”, should be construed in the same manner.

The same reference numerals indicate the same components throughout the specification. Meanwhile, the terms used in this specification are to describe the embodiments and are not intended to limit the present disclosure. In this specification, singular forms also include plural forms unless specifically stated otherwise in a phrase. As used herein, “comprises” and/or “comprising” include the stated component, step, operation, and/or element and do not preclude the presence or addition of one or more other components, steps, operations, and/or elements.

When a dry electrode is manufactured, a thickness of the dry electrode may be adjusted through rolling. As it is essential to make the thickness uniform, a pressure is controlled by a gap between press rollers in the current method of manufacturing the dry electrode. In this method, since thickness data of the electrode being actively manufactured is not taken into consideration, the uniformity of the thickness is inferior, and it is difficult to automatically control the dry electrode to achieve a target thickness.

Therefore, the present disclosure is directed to providing a method of controlling the thickness of the dry electrode capable of manufacturing the dry electrode having a target thickness through real-time automatic thickness control.

In particular, according to the present disclosure, the thickness and density of the dry electrode manufactured are measured using a radiation measuring device capable of accurately measuring the thickness. For example, the radiation measuring device may be an X-ray measuring device. In addition, the electrode having the target thickness may be accurately manufactured by feeding back the measured thickness and density data and automatically controlling a pressure of a press in real time. Moreover, according to the present disclosure, the thickness of the electrode can be stably controlled using a moving average control method.

Hereinafter, the present disclosure will be described in detail with reference to the accompanying drawings.

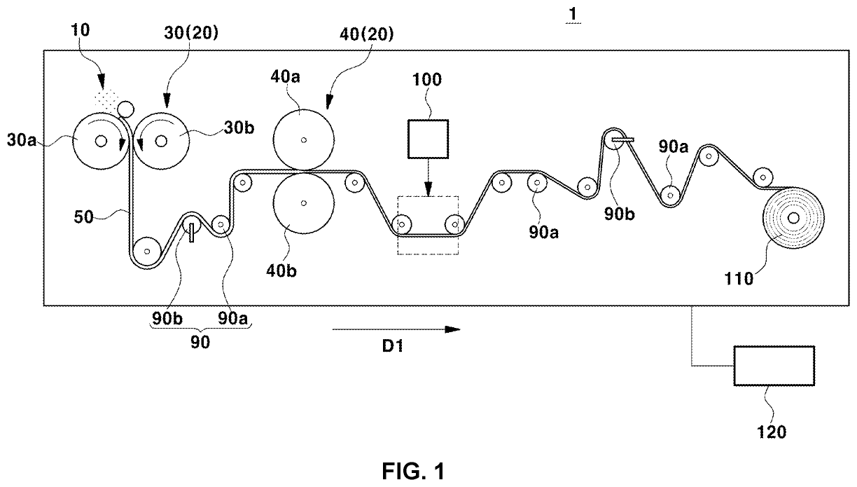

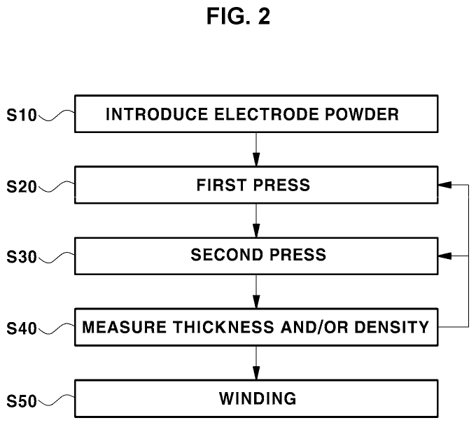

FIG. 1 schematically shows a configuration diagram of a system 1 for controlling the thickness of the dry electrode according to the present disclosure, and FIG. 2 schematically shows a control flow chart of the system 1 for controlling the thickness of the dry electrode.

The system 1 for controlling the thickness of the dry electrode includes a press 20 configured to roll an electrode powder 10. The press 20 may be a roll press. In one embodiment, the press 20 includes a first press 30 and a second press 40. The first press 30 is disposed upstream of the second press 40 in a proceeding direction of the electrode powder 10 or in a process direction D1.

The electrode powder 10 is formed in the form of a continuous film or an electrode sheet 50 while passing through the first press 30 and the second press 40 at S10, S20, and S30. The electrode powder 10 may be filmed while passing through the first press 30 to become the electrode sheet 50, and a thickness of the electrode sheet 50 may be further reduced through the second press 40 downstream of the first press 30 in the process direction D1.

The first press 30 may be configured so that the electrode powder 10 is injected in a vertical direction. In other words, a first roll 30a and a second roll 30b, which are two rolls of the first press 30, may be disposed horizontally with respect to each other.

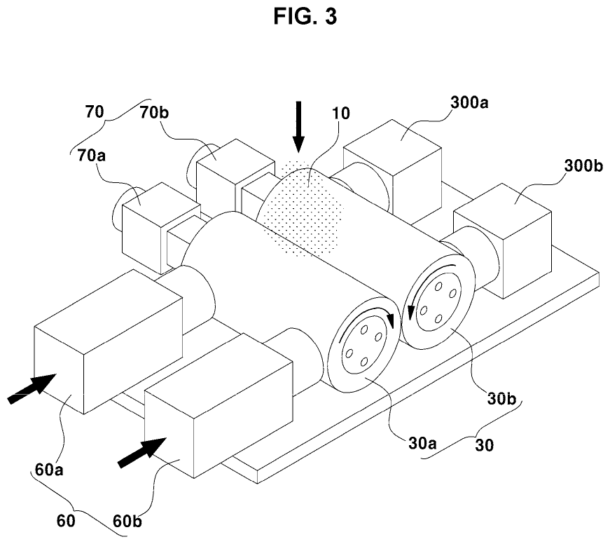

As shown in FIG. 3, a pressing force of the first press 30 may be adjusted. For example, the first press 30 includes the first roll 30a and the second roll 30b configured to rotate in opposite directions. The first roll 30a or the second roll 30b is respectively provided with pressing cylinders 60a, 60b (collectively, 60) to press both sides of the rolled electrode sheet 50 in a width direction W. In the shown embodiment, the pressing cylinder 60 disposed on the first roll 30a is shown.

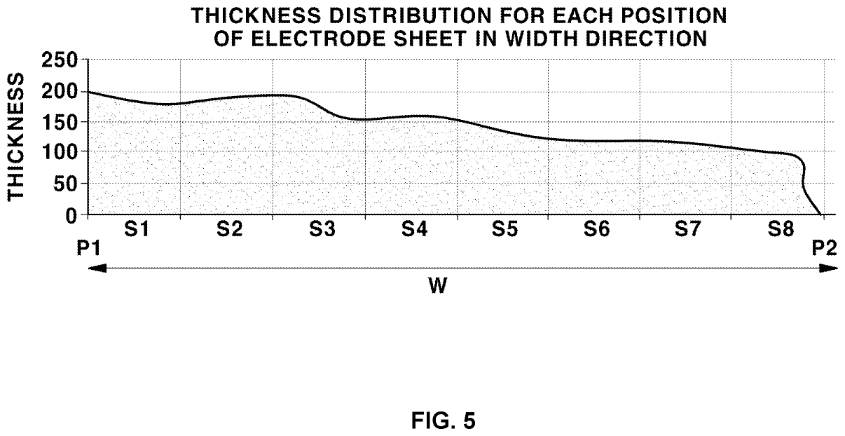

In the illustrated embodiment, a first region P1 of the electrode sheet 50 may also be pressed by the first pressing cylinder 60a, and a second region P2 may also be pressed by the pressing cylinder 60b in the width direction W. In addition, the first pressing cylinder 60a and the second pressing cylinder 60b may also be driven at the same time. Also, the pressing force of each pressing cylinder 80 may be adjusted. As a non-limiting example, the pressing cylinder 60 may be a hydraulically operated cylinder. However, other known devices other than hydraulic cylinders may be used as a device for providing the pressing force to the rolls 30a, 30b. P1 refers to the first region of the electrode sheet 50 in the width direction W, and P2 refers to the second region of the electrode sheet 50 in the width direction W, which is opposite to the first region (see FIG. 5). When the electrode powder is rolled, the thickness is not uniform in many cases, such as having greater or smaller thickness near both ends than in the middle area of the electrode sheet 50. Therefore, in particular, according to the present disclosure, two pressing cylinders are provided on each of the presses 30, 40 to be pressed on a region-by-region basis, thereby facilitating adjustment of the thickness.

A speed ratio of the rolls 30a, 30b of the first press 30 may be adjusted. To this end, the first press 30 is provided with a rotational driver 70. As a non-limiting example, the rotational driver 70 may be a servo motor but is not limited thereto, and other known actuators may be applied. Preferably, two rotational drivers 70 including a first rotational driver 70a and a second rotational driver 70b are provided for each roll 30a, 30b so that the speed of each of the rolls 30a, 30b may be individually controlled. The speed ratio of the first roll 30a and the second roll 30b may be adjusted by controlling driving speeds of each rotational driver 70. The thickness and density of the electrode sheet 50 manufactured by stretching through the control of the speed ratio may be controlled.

Load cells 300a, 300b are provided on the first press 30. The load cells 300a, 300b may measure the forces applied to the rolls 30a, 30b by the pressing cylinder 60. In one embodiment, the two load cells 300a, 300b may be provided on the first press 30. The first load cell 300a may be configured to measure the force in the first region P1, and the second load cell 300b may be configured to measure the force in the second region P2.

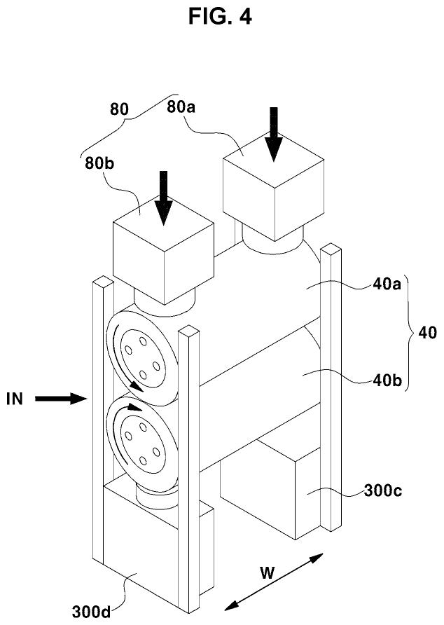

As shown in FIG. 4, the second press 40 may be configured so that the electrode powder 10 is introduced in a horizontal direction (indicated by IN). In this case, a first roll 40a and a second roll 40b, which are two rolls included in the second press 40, are disposed vertically.

The second press 40 includes a pressing cylinder 80. As in the pressing cylinder 60 of the first press 30, the pressing cylinder 80 of the second press 40 may also press the first region P1 of the electrode sheet 50 in the width direction W by the first pressing cylinder 80a and also press the second region P2 by the second pressing cylinder 80b. In addition, the first pressing cylinder 80a and the second pressing cylinder 80b may also be driven at the same time. The pressing force of each pressing cylinder 80 may be adjusted.

Load cells 300c, 300d are provided on the second press 40. The load cells 300c and 300d may measure the force applied to the second press 40 by the pressing cylinder 80. In one embodiment, the two load cells 300c, 300d are provided on the second press 40. The third load cell 300c may be configured to measure the force in the first region P1 of the electrode sheet 50, and the fourth load cell 300d may be configured to measure the force in the second region P2. A plurality of rollers 90 are disposed in the system 1 for controlling the thickness of the dry electrode. The roller 90 is configured to adjust a tension of the electrode sheet 50 under thickness control and guide a proceeding path. In one embodiment, the roller 90 may include a guide roller 90a capable of guiding the proceeding path of the electrode sheet 50 and a dancer roll 90b capable of adjusting the tension of the proceeding electrode sheet 50.

A measuring device 100 is disposed downstream of the second press 40. The measuring device 100 is configured to measure the thickness of the electrode sheet 50 at S40. As a non-limiting example, the measuring device 100 may be a radiation measuring device. A measuring head of the measuring device 100 may measure the thickness of the electrode sheet 50 along the width direction W while moving along the width direction W of the electrode sheet 50.

As shown in FIG. 5, a thickness distribution of the electrode sheet 50 along the width direction W of the electrode sheet 50 may be acquired by the measuring device 100.

The measuring device 100 may also measure the density of the electrode sheet 50. The density may be calculated based on a weight measured by the measuring device 100.

A winding roller 110 is disposed downstream of the measuring device 100. The winding roller 110 is configured so that the manufactured electrode sheet 50 is wound therearound. A plurality of rollers 90 may also be disposed between the winding rollers 110 of the measuring device 100. Each of the rollers 90a, 90b may adjust the tension of the electrode sheet 50 wound around the winding roller 110 and may be disposed at an appropriate position to guide the proceeding path.

In order to determine whether the thickness of the produced electrode is satisfied, conventionally, after manufacturing the electrode sheet, a manufacturing system is stopped, and then the thickness of the electrode sheet is measured with a manual measuring device. In other words, it is difficult to accurately control the electrode sheet to have the target thickness because the thickness may not be measured while the manufacturing system is being operated. The thickness measurement itself is not only manually performed but also requires a manual response when the target thickness is changed or the speed is changed. Besides, it is not possible to prevent the degradation of quality when the apparatus is continuously stopped and restarted to obtain the target thickness.

In contrast, the system 1 for controlling the thickness of the dry electrode according to the present disclosure may measure the thickness of the electrode sheet 50 in real time and perform feedback control so that the electrode sheet 50 has the target thickness based on the measured thickness.

The system 1 for controlling the thickness of the dry electrode includes a controller 120. The controller 120 is configured to control and supervise each component, such as the press 20 and the measuring device 100 of the system 1 for controlling the thickness of the dry electrode. Specifically, the controller 120 is configured to adjust the speed ratio and/or pressing force of the press 20 based on information measured by the measuring device 100. To this end, the controller 120 is configured to communicate with the measuring device 100.

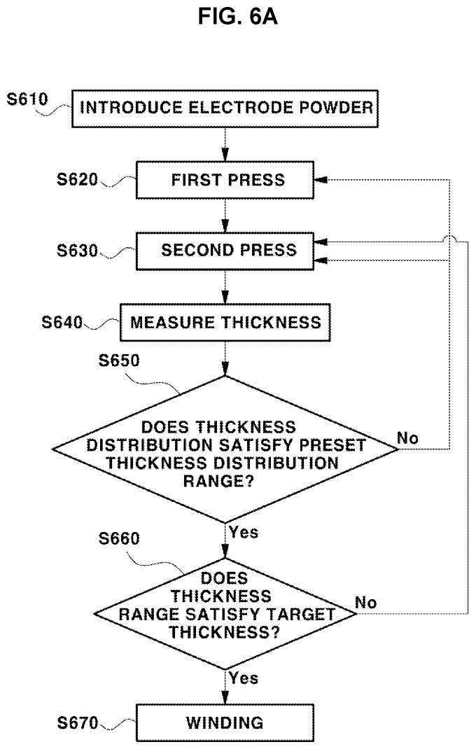

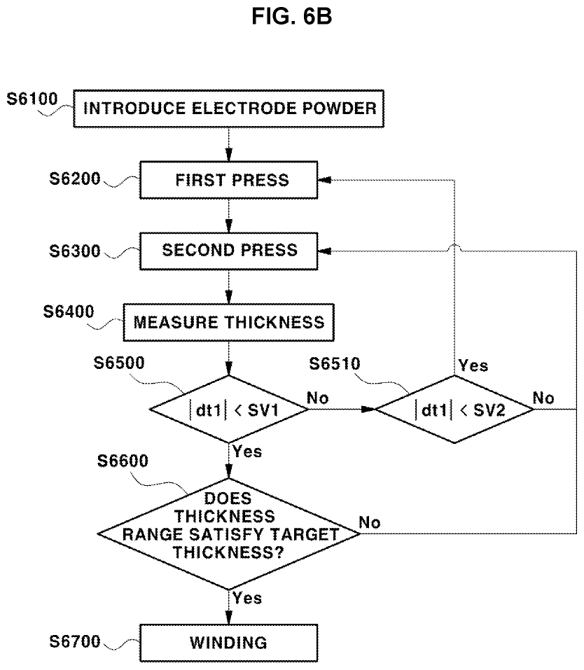

The thickness control of the system for controlling the thickness of the dry electrode according to some embodiments of the present disclosure will be described in more detail with reference to the flowchart of FIG. 6A.

At S610, the electrode powder 10 is introduced into the first press 30 for manufacturing the dry electrode. As the electrode powder 10 passes through the first press 30, the electrode powder 10 is filmed to form the electrode sheet 50 at S620.

Next, the electrode sheet 50 whose proceeding path is guided by the roller 90 reaches the second press 40 at S630. As the electrode sheet 50 passes through the second press 40, the thickness of the electrode sheet 50 becomes smaller.

At S640, the thickness of the electrode sheet 50 is measured by the measuring device 100 disposed downstream of the second press 40. As shown in FIG. 5, the measuring device 100 is configured to measure the thickness of the electrode sheet 50 in the width direction W and transmit the measured thickness distribution to the controller 120. Since the electrode sheet 50 is continuously manufactured, the thickness measurement may be consecutively performed at a regular time interval. Strictly speaking, the thickness of the electrode sheet 50 is discretely measured in consideration of a measurement time but may be continuously measured at a regular time interval. For example, when a time required for the measuring device 100 to measure the electrode sheet 50 having a width of 400 mm is 2 seconds, a new measurement data for another point of the electrode sheet 50 in the process direction D1 may be continuously acquired is performed at an interval of 2 seconds.

The controller 120 receives measurement information measured from the measuring device 100. The controller 120 observes a thickness distribution dt1 of the electrode sheet 50 and determines whether the thickness distribution dt1 satisfies a preset target distribution range at S650. Specifically, the thickness distribution dt1 is a thickness difference of the electrode sheet 50 in the width direction W, and the controller 120 calculates the thickness distribution dt1 that is a difference between the P1 side thickness and the P2 side thickness of the electrode sheet 50 (dt1=P1 side thickness t_P1-P2 side thickness t_P2). When the calculated thickness distribution dt1 is within the preset target distribution range, it is determined that a current thickness distribution is within an allowable range to proceed to S660.

Conversely, when it is determined that the thickness distribution dt1 does not satisfy the preset target distribution range, the difference between the P1 side thickness and the P2 side thickness is not within the allowable range. Then the controller 120 performs feedback control. The controller 120 may adjust the pressing forces of the first press 30 or the second press 40 according to how severe the difference in current thickness distribution is. Then the electrode sheet 50 newly passing through the first press 30 or the second press 40 is pressed by a pressing force adjusted to follow the target distribution range. For example, the electrode sheet 50 is intermittently pressed by the pressing cylinders 60, 80 of the side (P1 or P2) determined as having a greater thickness so that the thickness is uniform along the width direction W, that is, the thickness distribution dt1 is within the target distribution range.

Even at this time, since the thickness measurement is continuously performed, it is possible to confirm when the thickness difference in the width direction W is within the allowable range. The electrode sheet 50 having a uniform thickness may be manufactured by allowing the pressing cylinder 60 to press the electrode sheet 50 with the same pressing force under operating conditions when the measured thickness distribution dt1 is within the target distribution range.

When the thickness distribution dt1 satisfies the target distribution range, at S660, the controller 120 determines whether the electrode sheet 50 having uniform left and right thicknesses satisfies the target thickness. In particular, it is determined whether an average thickness of the electrode sheet 50 satisfies the preset target thickness range. Here, referring back to FIG. 5, the average thickness may be calculated by dividing the width of the electrode sheet 50 into eight sections S1 through S8 and calculating an average value thereof.

When the average thickness of the electrode sheet 50 satisfies the target thickness range, the electrode sheet 50 is wound at S670. In the opposite case, the controller 120 simultaneously presses or decompresses the electrode sheet 50 through the pressing cylinder 80 of the second press 40 so that the average thickness of the electrode sheet 50 satisfies the target thickness range at S660. Since the measurement by the measuring device 100 is continuously performed, the controller 120 may collect pressing conditions when the target distribution range and the target thickness range are satisfied after feedback control. Also, the controller 120 may allow the electrode sheet 50 to be manufactured under the collected pressing conditions. Accordingly, an electrode having a uniform and accurate target thickness may be manufactured.

Referring to FIG. 6B, according to some embodiments of the present disclosure, control conditions according to a size of the thickness distribution dt1 may be additionally provided so that the thickness distribution of the electrode sheet 50 is within the target distribution range. Operations S6100, S6200, S6300, S6400, and S6700 in the embodiment of FIG. 6B may correspond to operations S610, S620, S630, S640, and S670 in the embodiment of FIG. 6A, so descriptions about operations S6100, S6200, S6300, S6400, and S6700 are omitted.

The thickness distribution dt1 measured at S6500 are compared with a first set value SV1. When an absolute value of the thickness distribution dt1 is smaller than the first set value SV1, the process proceeds to S6600. When the absolute value of the thickness distribution dt1 is smaller than the first set value SV1, it is determined that the difference between the P1 side thickness and the P2 side thickness is within the target distribution range.

Conversely, when the absolute value of the thickness distribution dt1 is greater than or equal to the first set value SV1, the absolute value of the thickness distribution dt1 is compared with a second set value SV2 at S6510. Here, the first set value SV1 is a natural number smaller than the second set value. For example, the first set value SV1 is 2 micrometers, and the second set value SV2 is 10 micrometers.

It is determined that the thickness distribution dt1 in which the absolute value of the thickness distribution dt1 is greater than or equal to the first set value SV1 does not satisfy the target distribution range. In addition, based on the comparison between the second set value SV2, which is a value greater than the first set value SV1, and the absolute value of the measured thickness distribution dt1 at S6510, the controller 120 is configured to adjust the pressing force of the first press 30 or the second press 40.

Specifically, when the absolute value of the thickness distribution dt1 is greater than the second set value SV2, the pressing force of the first press 30 is adjusted. In this case, since it is determined that the thickness distribution dt1 of the P1 side and the P2 side of the electrode sheet 50 is excessive, the pressing force may be adjusted by a method of increasing the pressing force of the first press 30 for the side having the greater thickness or the like. Alternatively, the thickness distribution dt1 may be reduced by adjusting an amount of the electrode powder 10 introduced into the first press 30.

Conversely, when the absolute value of the thickness distribution dt1 is smaller than or equal to the second set value SV2, the pressing force of the second press 40 is adjusted. In this case, it is determined that the thickness distribution dt1 of the electrode sheet 50 may be adjusted by the second press 40. The pressing force may be adjusted by a method in which the controller 120 increases the pressing force for the side having the greater thickness and reduces the pressing force for the side having the smaller thickness through the second press 40 or the like.

As described above, when the pressing force of the first press 30 or the second press 40 is adjusted according to the comparison result between the absolute value of the thickness distribution dt1 and the second set value SV2, the thickness may be adjusted more effectively and efficiently. In other words, the first press 30 may greatly contribute to reducing or increasing the thickness of the electrode sheet 50, and the thickness distribution of the electrode sheet 50 may be finely corrected through the second press 40. In the first press 30, since the powder 10 is introduced, the thickness of the electrode sheet 50 is determined by a small gap that is set between the first roll 30a and the second roll 30b. Therefore, the first press 30 may effectively correct the thickness distribution dt1 of the electrode sheet 50 when the thickness distribution dt1 of the electrode sheet 50 is relatively large, and the second press 40 may finely correct the thickness distribution dt1.

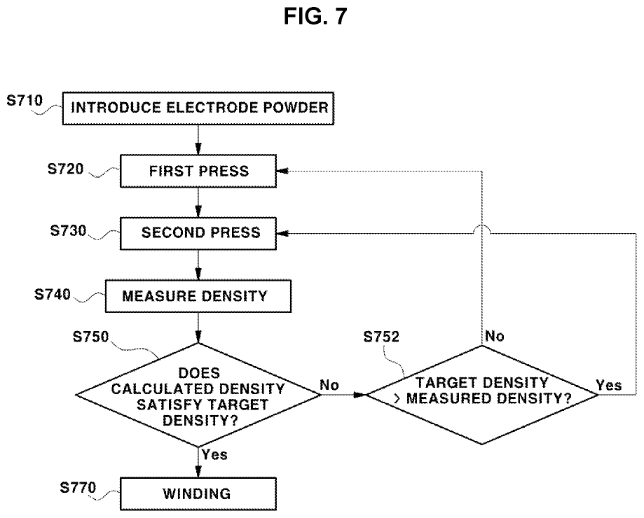

At S6500, when it is determined that the absolute value of the thickness distribution dt1 is smaller than the first set value SV1, S6600 may be performed. Referring to FIG. 7, according to some embodiments of the present disclosure, the measuring device 100 is configured to measure the weight of the electrode sheet 50. The controller 120 may calculate the density of the electrode sheet 50 based on the measured weight and thickness. In particular, according to the present disclosure, the manufacture of the electrode sheet 50 is controlled based on the calculated density.

While the electrode sheet 50 is manufactured through S710, S720, and S730, the measuring device 100 measures the weight of the electrode sheet 50 at S740. Operations S710, S720, S730, and S770 in the embodiment of FIG. 7 may correspond to operations S610, S620, S630, and S670 in the embodiment of FIG. 6A, so detailed descriptions about operations S710, S720, S730, and S770 are omitted. For example, a radiation measuring device may measure the weight of a material in an area of 1 square meter. The controller 120 is configured to calculate the density based on the measured weight information. The density may be calculated by dividing the acquired weight by a volume of the electrode sheet 50 acquired based on the measured thickness information. The density may be continuously calculated at a preset time interval.

The controller 120 compares a target density and the calculated density at S750 and S752. When the difference between the target density and the calculated density is within a preset reference density difference range, the controller 120 winds the electrode sheet 50 to terminate the manufacture at S770. For example, the preset reference density difference may be 0.15 grams/cubic centimeter (g/m³).

Conversely, when the difference between the target density and the calculated density is out of the preset reference density difference range, the controller 120 changes driving conditions of the press 20. When the calculated density is greater than the target density at S752, the speed ratio of the rolls 30a, 30b of the first press 30 may be controlled, and the density may be reduced by the stretching of the electrode sheet. Conversely, when the calculated density is smaller than the target density, the density is increased by pressing the second press 40.

According to the present disclosure, a moving average value is used as the measurement values of the thickness and/or the density. Since the electrode sheet 50 supplied to the measuring device 100 continues to move, it is determined whether the thickness and/or the density are within the allowable range based on the moving average of a plurality of measured thickness values measured at each time point.

In particular, at the initial stage of manufacturing the electrode sheet 50, the controller 120 is configured to acquire a plurality of thickness measurement values measured at each time point by the measuring device 100. For example, the controller 120 may receive 30 thickness measurement values measured by time, for example, every 2 seconds, from the measuring device 100 and then use the calculated moving average as the thickness measurement value.

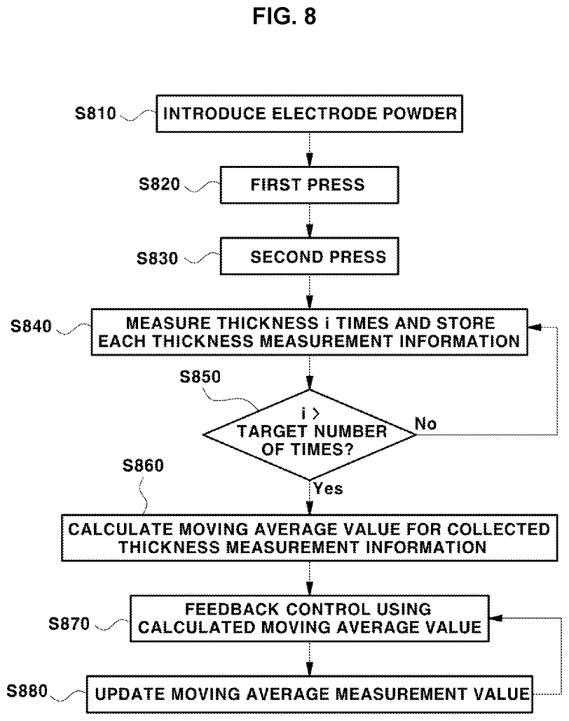

Specifically, referring to FIG. 8, when the electrode sheet 50 starts to be manufactured, the electrode powder 10 passes through the first press 30 to be filmed at S810 and S820, and the thickness thereof becomes smaller as the electrode powder 10 passes through the second press 40 at S830. The thickness of the electrode sheet 50 passing through the measuring device 100 is continuously measured and stored consecutively from the first of the number of measurements (i) at S840. The controller 120 determines whether the number of measurements (i) exceeds a preset target number of times, for example, 30 times at S850. In addition, the controller 120 continuously calculates a moving average value for measurement information measured for 30 times.

When it is determined that the number of measurements (i) exceeds the target number of times, the controller 120 is configured to perform feedback control based on the moving average (initial moving average) of the measurement values calculated so far at S860 and S870. While the electrode sheet 50 is continuously supplied, the thickness is measured, the initial moving average is continuously updated, and the feedback control is performed at S880. In other words, the feedback control for the thickness measured at S640 of FIG. 6A or at S6400 of FIG. 6B and the density or weight measured at S740 of FIG. 7 are performed based on the moving average rather than real-time measurement values.

As described above, according to the present disclosure, since the feedback control is performed based on the moving average, the thickness of the electrode sheet 50 that changes in real time may be stably controlled.

Meanwhile, in the embodiment of FIG. 7, the number of measurement values acquired to obtain the moving average may be adjusted according to a distance between the measuring device 100 and the press 20.

According to the present disclosure, it is possible to automatically measure the thickness of the electrode without manual measurement.

In addition, according to the present disclosure, since the real-time thickness measurement is possible, it is possible to minimize the loss due to the manufacture of an electrode having a large deviation in thickness distribution.

According to the present disclosure, it is possible to form an electrode having an accurate target thickness and density. According to the present disclosure, it is possible to manufacture an electrode having a uniform thickness distribution.

According to the present disclosure, it is possible to quickly acquire accurate process conditions such as pressure and speed based on the automatically measured data.

The present disclosure described above is not limited by the above-described embodiments and the accompanying drawings, and it will be apparent to those skilled in the art to which the present disclosure pertains that various substitutions, modifications, and changes are possible without departing from the technical spirit of the present disclosure.

1. A system for controlling a thickness of a dry electrode, the system comprising:
a first press configured to accommodate an electrode powder and press the electrode powder into an electrode sheet in the form of a film;
a second press positioned downstream of the first press, the second press being configured to receive and to press the electrode sheet;
a measuring device positioned downstream of the second press and configured to measure a thickness of the electrode sheet in real time; and
a controller configured to change an operating condition of the first press or an operating condition of the second press based on thickness information measured by the measuring device.

2. The system of claim 1, wherein the thickness information is a moving average of the thickness information measured at a plurality of time points.

3. The system of claim 2, wherein during an initial driving of the system for controlling the thickness of the dry electrode, the moving average of the thickness information uses a moving average value calculated after the thickness information is acquired at time points of the preset number of times.

4. The system of claim 1, wherein the operating condition of the first press is a pressing force of the first press, and the operating condition of the second press is a pressing force of the second press.

5. The system of claim 1, wherein the measuring device is a radiation measurement device.

6. The system of claim 5, wherein the radiation measurement device is configured to measure a thickness distribution of the electrode sheet in a width direction.

7. The system of claim 1, wherein the first press is configured to provide different pressing forces to at least two regions of the electrode sheet, and
wherein the second press is configured to provide different pressing forces to the at least two regions of the electrode sheet.

8. The system of claim 7, wherein the controller is configured to adjust an operation of the first press or the second press when a thickness distribution of the electrode sheet acquired based on the measured thickness information does not satisfy a preset target distribution range.

9. The system of claim 8, wherein when an absolute value of the thickness distribution is greater than a preset first set value and greater than a preset second set value, the controller is configured to adjust the operation of the first press, and the second set value is greater than the first set value.

10. The system of claim 8, wherein when an absolute value of the thickness distribution is greater than a preset first set value and smaller than or equal to a preset second set value, the controller is configured to adjust the operation of the second press, and the second set value is greater than the first set value.

11. The system of claim 8, wherein the thickness distribution is a difference between thicknesses of a first region and a second region of the electrode sheet in the width direction.

12. The system of claim 7, wherein the controller is configured to adjust the operation of the second press when a thickness distribution of the electrode sheet acquired based on the measured thickness information satisfies a preset target distribution range but an average thickness acquired based on the measured thickness information does not satisfy a preset target thickness range.

13. A system for controlling a thickness of a dry electrode, the system comprising:
a first press configured to accommodate an electrode powder and to press the electrode powder into an electrode sheet in the form of a film;
a second press positioned downstream of the first press and configured to receive and to press the electrode sheet;
a measuring device positioned downstream of the second press and configured to measure a weight of the electrode sheet in real time; and
a controller configured to calculate a density of the electrode sheet based on weight information measured by the measuring device, and to change an operation condition of the first press or the second press based on the calculated density.

14. The system of claim 13, wherein the weight information is a moving average of weight information measured at a plurality of time points.

15. The system of claim 14, wherein during an initial driving of the system for controlling the thickness of the dry electrode, the moving average of the weight information uses a moving average value calculated after weight information is acquired at time points of the preset number of times.

16. The system of claim 13, wherein the operating condition of the first press is a speed ratio of a first roll and a second roll included in the first press.

17. The system of claim 13, wherein the operating condition of the second press is a pressing force of the second press.

18. The system of claim 13, wherein when the calculated density does not satisfy a target density, the controller is configured to change the operating condition of the first press or the second press.

19. The system of claim 13, wherein the controller is configured to adjust a pressing force of the second press when the calculated density is smaller than a target density.

20. The system of claim 13, wherein the controller is configured to adjust a speed ratio of a first roll and a second roll configured so that the electrode sheet passes when the calculated density is greater than or equal to a target density.
